(19) United States
(12) Patent Application Publication
(10) Pub. No.: US 2010/0327073 A1
(43) Pub. Date: Dec. 30, 2010

(54) WATER FEATURE AND METHODS

(75) Inventor: Ross C. Kette, Sandusky, OH (US)

Correspondence Address: HAHN LOESER & PARKS, LLP, One GOJO Plaza, Suite 300, AKRON, OH, 44311-1076, US

(73) Assignee: RAIN DROP PRODUCTS, LLC, ASHLAND, OH (US)

(21) Appl. No.: 12/494,512

(22) Filed: Jun. 30, 2009

(51) Int. Cl. B05B 17/08

(52) U.S. Cl. 239/8; 239/17

(57) ABSTRACT

There is provided a water feature and methods for use in a water park type environment wherein the feature comprises a misting system for dispensing a fluid in the form of a mist in an aesthetically pleasing and interactive arrangement. In an example, the misting system comprises a source of fluid coupled to a high pressure pump, and a conduit member having a first end that is attached to the source of high pressure fluid produced from the pump. At least one misting nozzle is coupled to the conduit to selectively disperse the fluid at a localized area upon actuation of at least one fluid control valve. A control system may also be provided to provide selective control of the supply of high pressure fluid to the at least one misting nozzle. The control system may allow interaction by a user to allow a user to control actuation of the supply of high pressure fluid to the at least one misting nozzle. The water feature may be an above ground or below ground feature, and may be provided as a transportable, stand-alone system.

### TECHNICAL FIELD

There is provided a water feature and methods for use in a water park type or other environment wherein the feature comprises a misting and/or fogging system for dispensing a fluid in the form of a mist or fog in an aesthetically pleasing and interactive arrangement.

### BACKGROUND

Water parks, water playgrounds, water spray parks and the like (hereafter collectively referred to as water parks) are becoming increasingly popular. Such water parks or facilities having water-oriented themes may include different areas like amusement parks, or increasingly, municipalities, communities and the like are providing water themed parks instead of community swimming pools or the like. Water recreation has long been highly desirable to people, which offer fun and recreation to users. There has particularly been significant growth in the development of such facilities by communities or entities within communities. Areas in amusement or water parks, and community water themed parks may have play structures that are designed to spray, splash, soak dump or otherwise allow users to interact with water themed features.

In implementing such facilities, it is desirable to provide the facility with attractions or a design which is appealing to people including children, which in itself has led to the development of theme oriented water parks and attractions. At the same time, it is also desirable to provide facilities which are easily operated, and which are safe for use by many different people. The cost of operating such facilities is also a consideration, which can include significant costs due to water usage.

In such water parks, water features may be used in conjunction with a pool or without requiring a pool. The water features are of various types, including both above grade and below grade features. The above and below grade features include fixtures for receiving and dispensing water. The water features in many cases are disposed around an area, and water is typically dispensed from a main reservoir via pumping and conduit systems.

Notwithstanding the state of the art as described herein, there is a need for further improvements in the types of water features that may be used in such water parks. It would be desirable to provide new water features which would enhance the water park design. Further, it would be desirable to provide a water feature which can be adapted to provide different water spray and dispensing characteristics for use in water parks. Water play apparatus may be designed to permit interactive participation by a user, as for example, by having user activated operation or changes in operation that can be controlled by the user.

There further has been developed the use of misting devices, such as for industrial use in control environmental conditions in greenhouses, or other environments, dust and fire suppression. Also, misting systems are used for keeping objects cool or moist, such as vegetable produce and, in recent years, misting systems have become more popular for cooling people or animals, such as people at sporting events or the like. Personal water misting systems have also been developed for use in hot environments, such as at the beach or the like.

Though misting systems are useful for such applications, it would be desirable to provide water misting systems associated with features in water parks. It would also be desirable to provide a water misting systems that allow interaction therewith, and have reduced water usage requirements' in operation thereof.

It would also be desirable to provide misting systems that are usable as stand-alone, transportable systems, for use in other environments such as camps, parks, and other places where temporary use for recreation or another purpose.

### SUMMARY

The present invention generally comprises a water feature apparatus and methods incorporating misting systems that selectively dispense a fluid in the form of a mist and/or fog type of emission for providing a unique appearance and evaporative cooling of a localized area. In an example, the misting system comprises a source of fluid under pressure, either from municipal pressure or higher pressure produced from a high pressure pump. For higher pressure systems, the source of fluid may be coupled to a high pressure pump, and a conduit member having a first end that is attached to the source of high pressure fluid produced from the pump. At least one misting nozzle is coupled to the conduit to selectively disperse the fluid in a localized area upon actuation of at least one fluid control valve provided in association therewith. A fluid control valve may be coupled to selectively supply high pressure fluid to the at least one misting nozzle, or a plurality of fluid control valves may be provided in association with a plurality of misting nozzles, to selectively supply high pressure fluid to individual misting nozzles. A control system may also be provided to provide selective control of the supply of high pressure fluid to the at least one misting nozzle. The control system may allow interaction by a user to allow a user to control actuation of the supply of high pressure fluid to the at least one misting nozzle. As described herein the term “misting” or “misting nozzle” refers to a mist type and/or fog type of emission, and the term “misting nozzle” refers to a spray nozzle that dispenses a mist type and/or fog type of emission. A system using pressurized fluid from a lower pressure source, such as a municipal water supply system, may be used to produce mist type of emissions, while higher pressure systems may be used to produce mist and/or fog type of emissions generally, but dispensing characteristics generally depend on nozzle and pressure characteristics. The system may also comprise additional features such as a lighting system, fan system or other systems usable in association with the water feature. Such additional features may also be user controlled if desired. The water feature may be an above ground or below ground feature, and may be provided as a transportable, stand-alone system.

There is also provided a method for providing interactive play with a water feature comprising providing a water feature including a misting system that selectively dispenses a fluid in the form of a mist and/or fog for providing evaporative cooling of a localized area. The method includes selectively coupling a source of high pressure fluid to at least one misting nozzle provided as part of the water feature, wherein the supply of high pressure fluid to the at least one misting nozzle is controlled by a control system operating the water feature. The control system may be user actuated.

In another aspect, the systems and methods may include a misting manifold having a plurality of misting nozzles. The misting manifold may have a plurality of tubing sections, with liquid communication to each of the sections by one or more supply lines. The design of a misting manifold may be tailored to a desired application or location, each manifold being custom designed for the application or area desired to be misted or fogged. After the configuration of the desired misting and/or fog pattern is ascertained, a suitable combination of tubing, intermediate members and tubing is selected to assemble a suitable misting manifold that will result in a desired misting and/or fog pattern. The tubing sections may be encompassed in an outer housing, such as having a form as a water feature with aesthetic appeal. A nozzle extender may be used, that is inserted into a branch channel of the supply system, with a nozzle provided at its other end. The system may also have user actuated valves or other controls to control dispensing of water or other fluid from the one or more misting nozzles, or to control the direction or characteristics of the dispensing, or even the position of individual nozzles. The system could also be provided as a stand-alone, mobile system to allow it to be moved and positioned at a desired location, and coupled to an existing water supply for operation.

### BRIEF DESCRIPTION OF THE DRAWINGS

FIG. 1 is a schematic view of a water feature system according to an example of the invention;

FIG. 2 is a front schematic view of an alternate example of a stand-alone water feature system according to the invention;

FIG. 3 shows an example of an above-ground water feature into which the misting/fogging systems may be incorporated;

FIG. 4 shows an example of an above-ground water feature into which the misting/fogging systems may be incorporated;

FIG. 5 shows of a water feature including a misting system nozzle arrangement according to an example of the invention;

FIG. 6 shows an enlarged sectional view of a misting nozzle arrangement including an access panel according to an example; and

FIGS. 7a-7d are views of examples of water features according to the invention.

### DETAILED DESCRIPTION OF THE DRAWINGS

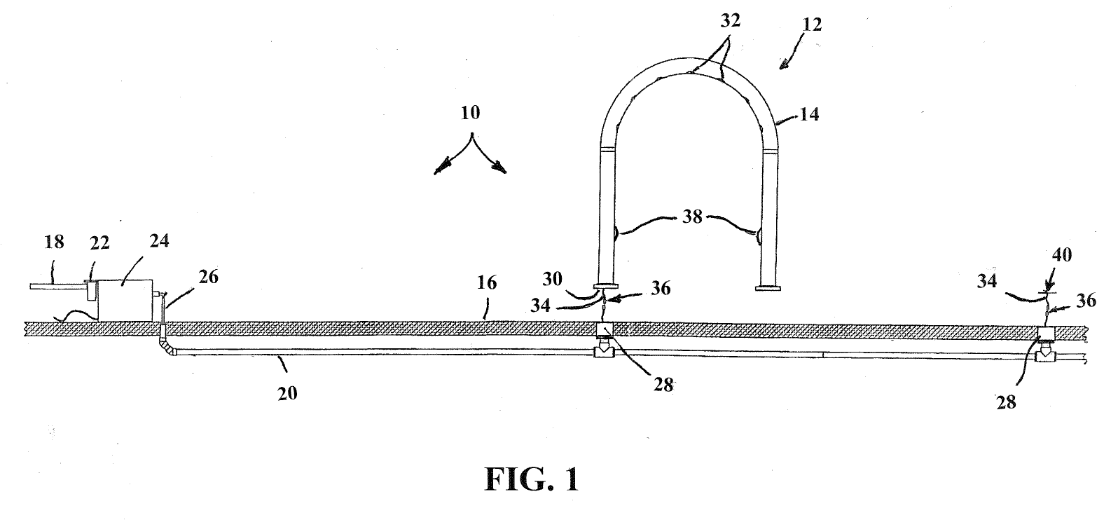

With reference now to the drawings, and in particular to FIG. 1, a misting system 10 is shown in an example of the principles and concepts of the present invention. FIG. 1 illustrates a user interactive water play device or system 10 for use in a water park in accordance with an example of the invention. As mentioned previously, the term water parks can refer to water playgrounds, water spray parks, water parks with attractions and other environments where water is an aspect of recreation or entertainment for example, all of which will hereafter collectively be referred to as water parks. The system 10 is shown with respect to an above ground water feature 12, such as a water spray tube 14 which extends from the ground or base surface 16, and may have any of a wide variety of forms. The feature 12 in this example is shown as a u-shaped tube 14 having a height to allow people to walk/run through it for example. Such a feature 12 would also allow people in wheelchairs, bicycles or the like to pass through and experience the misting/fogging environment created. In some water park environments, the feature 12 may be built into the park, and selectively connected to a water supply system (not shown) via a water supply line 18. The water supply may be connected through line 18 to a high pressure line 26, which may be connected to the feature 12 through a conduit 20. As will be described, different pressure may be used to dispense the fluid from the feature 12, and a high pressure line 26 may not be required to handle the pressures at which the fluid is supplied. A suitable filtration system 22 may be used to filter the water and prevent any clogging of the misting nozzles. To provide misting and/or fogging capabilities, the water from supply line 18 is pumped under high pressure by a high pressure/low flow pump 24, which supplies high pressure water through a high pressure line 26. The conduit 20 facilitates protecting the high pressure line, but may not be used if desired. Further, the conduit 20 may be used in association with or separate from plumbing that may supply water under normal pressure to the feature 12.

As shown in this example, the high pressure line 26 and/or conduit 20 may extend to a mounting fixture 28, which may be a universal mounting fixture for installation of an associated water feature 12 apparatus. The universal mounting fixture may be similar to that described in U.S. Published Patent Application No. 20070105635 for example, which comprises a housing designed to be cast in position within a water park surface. The housing has an interior sealing surface, and an inlet adapted to be coupled to a water supply for providing water to a water feature mounted in association with the housing. The water feature 12 has an inlet 30 for engaging and sealing with the sealing surface. The mounting fixture 28 can accommodate both inlets from above grade and below grade water feature fixtures for example. The use of a universal mounting fixture and associated water feature, which may be both above grade and below grade water features, allows the interchangeability of water features within a water park, providing flexibility in changing the design of the water park and features, without requiring reconfiguration of the water supply system or other aspects of the water park design. The water feature may have misting and/or fogging features either alone or in combination with other water dispensing features such as spraying, splashing, dumping or the like. The misting and/or fogging features are provided by one or more misting nozzles 32. The mist producing nozzles are supplied with pressurized water. In examples as will be described in more detail, the misting system may be supplied with water under normal municipal pressure, which may be in a range of 10-400 psi for example, or may be supplied at higher pressures, such as between 400-1200 psi. The pressure of the supplied fluid may be set to achieve desired dispensing characteristics in association with the misting nozzle being used. In the event that higher pressures are used to supply the fluid to the misting nozzle(s), a high pressure line 26 may be used. The feature 12 may have a corresponding high pressure line 34, which may be coupled to the line 26 via a quick connection coupling 36 for example. The misting components, such as the nozzles 32, high pressure line or hose 26 and 34, positive pressure pump 24, and/or filter system 22 may be of any suitable type. The misting nozzles 32 for example may operate at between 10 to 1200 psi or other suitable pressures. The filtration system 22 may be used to prevent clogging or the misting nozzles for example, using any type of suitable filtering system. The lines 26 and 34 may be formed from filament strands of polyester and resin such as fiberglass or other plastic composites, where the lines allow flexure while providing desired strength for the high pressure fluid. In an example, the misting nozzles 32 may operate to produce spray drop sizes having a volume median diameter (VMD) in the range of 1 micron to 5,500 microns, or in a range of 20 microns to 4300 microns, but other suitable droplet sizes may be used to provide the aesthetic dispensing characteristics as desired. VMD is a measure of the droplet size produced from the spray nozzle 32, and represents the droplet size at which one-half of the droplets comprise larger droplets and one-half comprise smaller droplets.

The feature 12 may further have one or more sensors 38 that allow interactive play or operation of the feature. The interaction with the feature(s) may be solenoid (or otherwise) activated in association with one or more sensors 38, such as based on motion, step on sensors, switches, or the like. Activation can be automatic or manual, with one or more sensors 38 turning individual features or nozzles 32 on/off, to change or modify spray patterns. Different nozzles 32 may have different spray patterns, such as for example, flat, cone or whirling patterns, or any other pattern that may be desired. For example, a series of buttons/keys may be provided to actuate individual or groups of mist nozzles 32. Other features, such as playing music or turning on/off lights, along with spray of mist from individual or groups of nozzles may be provided. A manifold with plural nozzles 32 could be individually controlled via individual solenoids. If desired, the nozzles 32 may be configured to allow the direction or amount of mist emitted therefrom to be modified for interactive play, or even the position of the nozzles selectively changed for interactive play with the feature 12. Any other suitable approaches to activate, control or modify operation of the feature 12 or 40 may be utilized.

If desired, the high pressure line 26, with or without the conduit 20, may also supply other features, such as a below ground feature 40 with one or more misting nozzles associated therewith as shown in FIG. 1. In such an arrangement as shown in FIG. 1, any feature in a water park may have high pressure hose and one or more mist nozzles installed in the feature. A quick disconnect fitting 36 may be used to selectively connect the feature into the high pressure system running under ground. The distribution of the high pressure hose 26 may be run underground through electrical conduit or pipes 20, or in any other suitable manner. The hose 26 and/or conduit 20 could be separate or run within a normal plumbing. In a water park environment, each feature location designed into the park could be made to accept either or both normal plumbing or high pressure plumbing for use of typical water features, misting and/or fogging features or combination features. In the example shown, the conduit or pipes 20 may have a universal mounting fixture at each location so a “tee” fitting can be installed easily as the hose 26 is fished through the conduit, and the female end of the quick disconnect 36 is installed for feature connection. The features 12, 40 and possibly others, can be run either in a series or a parallel fashion, and controlled by sensors 38, or solenoid controlled valves connected to a central controller/processor, to activate and control the features, or in other suitable manners. The pump 24 and filter system 22 may be housed in a pump house, a vault, a faux rock, faux tree stump, a drinking fountain or any other suitable arrangement. The supply water may be from a municipal or potable water source.

The system pressure may vary depending on the application and the mist nozzles selected for use. For example, the pressure may be in the range from 10 psi to 3000 psi, but other pressures may also be suitable. The higher pressures are used particularly when ultra fine droplets are desired to atomize the water to produce a fog like appearance. In general, the systems and methods according to the invention may provide for the production of mist and or fog type emissions for generating desired characteristics in association with a particular feature. Mist type emissions may be provided by lower pressure systems, such as between about 10 to 400 psi, and/or in association with particular nozzle configurations adapted to produce more of a misting type emission. More particularly, low pressure systems in the range of about 30 to 100 psi may produce misting type emissions for desired aesthetic considerations. A fog type of emission may be produced by higher pressure systems, such as between about 400-3000 psi, and/or in association with particular nozzle configurations adapted to produce more of a fog type emission. More particularly, high pressure systems in the range of about 700 to 1000 psi may produce fog type emissions for desired aesthetic considerations. Suitable nozzle configurations suitable for production of both mist and fog type of emissions may be of many types, such as produced by Spraying Systems Co. of Wheaton, Ill. Though particular nozzles may be used to produce mist or fog effects, the same nozzles may produce both depending on the pressure of the supply fluid. Different mist and/or fog effects may also be produced in a feature by use of both high and low pressure systems and/or different nozzle configurations. Further, though water may be used as the fluid to create the misting and/or fog effects, the water may be colored, or another suitable fluid used if desired.

In an example, the typical usage of water is 0.0145 gpm per nozzle 32 installed, such that overall water usage is relatively low, thereby reducing the costs associated with water usage. In a water park having multiple play features, water usage may be under 2 gpm, whereas in use of other water play features, the typical water to waste water park may use 50-500 gallons per minute. In use of the system 10, there may also be provided a water recirculation system to capture and recirculate water dispensed from misting and/or fogging or regular water features in the water park. As should be recognized, the advantage of misting and/or fogging features for water to waste is the extremely low usage of water, while still providing aesthetically pleasing features that people and children can enjoy. The cost of installation, equipment, and operating can thus be far less with misting and/or fogging features either alone or in conjunction with other water features. The advantage of providing recirculation is the recapture and reuse of water, but may further include equipment for filtration and sanitization of the recaptured water. The equipment for recirculation may include one or more reservoirs, filtration pump(s), feature pump(s), sand filter, chlorination or other sanitation system, and/or an ultraviolet system for example, or other systems for treatment and recirculation of the fluids.

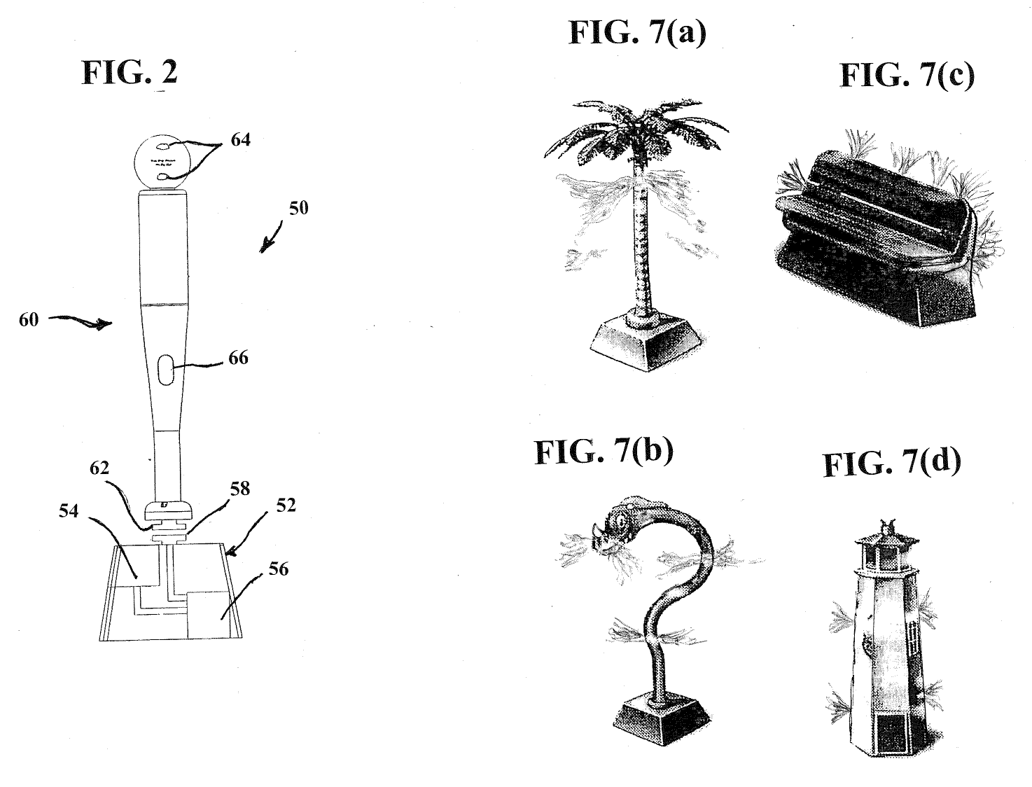

In another example of the invention, the water feature may be a stand-alone, mobile or portable system 50 as shown in FIG. 2. A portable or mobile type of interactive water feature provides the ability to use such a system in any location, in conjunction with events or even simply just in a personal manner, such as in the yard of a home or the like. A self-contained unit 50 may have a base 52 which includes a reservoir 54 and a high pressure pump 56. The base 52 may be a fiberglass housing or any other suitable configuration, and may be of any desired size. If desired, wheels or other suitable mechanism to facilitate transport of the base can be provided. Alternatively to a supply reservoir 54, the pump 56 may be supplied with water from any suitable water supply, such as a normal household water supply via a garden hose or the like. The pump 56 may be operated via 110 Volt household electrical power, or could be operated using a battery system to allow operation where electrical power is not available. In an example, the reservoir 54 could be about a twenty (20) gallon tank, with the feature having high pressure mist nozzles 64 that use a low water volume, such that use of the unit 50 could last for about four (4) hours or so. The unit 50 could be temporarily hooked up to an electrical source such as a generator if no electric power is available in proximity. The base 52 may include a quick coupler 58 that allows universal coupling to a water feature 60 via a mating coupler 62. The feature 60 includes at least one misting nozzle 64. If some examples, the pump 56 may not be needed if mist nozzles 64 that can use municipal pressure (low pressure) are provided. A sensor or switch 66 may be provided for activating the operation of the feature 60. Though a single feature 60 is shown in the example, the base 52 and associated pump 56 could supply high pressure water to multiple features if desired, either associated with the same base 52 or via series or parallel connection to separate features (either alone or in conjunction with base members 52).

The stand-alone unit 50 could alternatively be provided with the pedestal or housing 52 provided inside the feature 50, such that the exterior of the unit 50 would have the appearance of an object or thing, and could have plumbing and/or electrical supplied underground to it instead of having the reservoir 54 and pump 56 associated therewith. The plumbing and/or electric could then be coupled to the unit 50 for operation whenever desired. In any example, the unit 50 can be easily moved for storage or to another area for use as may be desired.

The misting and/or fogging features may be used in a variety of environments such as, merely for examples, water parks, municipal or other parks, zoos, sports venues, amusement parks, camps, playgrounds, yards or a variety of other venues or places. The purpose is to provide entertainment both visually, and actively. The misting and/or fogging features could be an option that could be installed in any water interactive feature, or in association with any theme water play feature.

The devices further provide the ability to cover a large area, so that an entire group of people is cooled, and according to the example above, could still remain portable. In operation, the misting systems may produce from each misting nozzle, a stream of ultra-fine aerosol-sized droplets of water or other liquids, when a mist or a fog is desired. The misting systems may also used to produce effects like fog. In hot outdoor environments, the ultra-fine water droplets produced by suitable nozzles are introduced into the air where they may flash evaporate, dissipating heat and resulting in the cooling in the vicinity. The features according to the invention may also provide the misting systems with a fan or other device to move the misted air about in a particular manner. In general, the nozzles are attached to a manifold of suitable tubing and liquid is pumped through the tubing to carry the liquid to the nozzles to produce the mist or fog. The invention may use laminar flow nozzles that provide a water spray of fine droplets.

If desired, the system of the invention could also be provided with one or more sensors arranged in the environment to sense the humidity and/or temperature, and a control device for actuating mist or spray heads to apply mist or spray to the surrounding area.

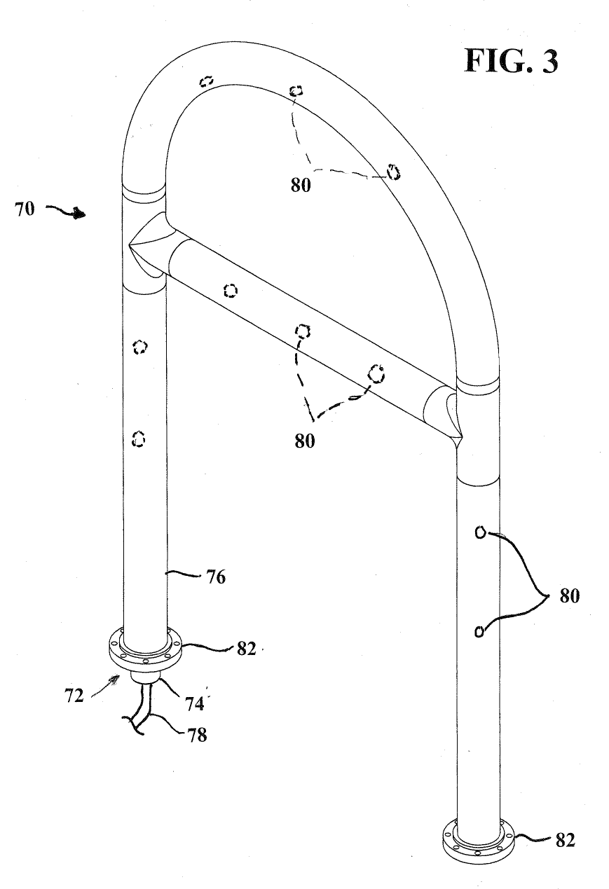

In FIG. 3, there is shown an example of a above-ground water feature which may incorporate the misting/fogging nozzles according to the invention. The above-ground water feature 70 may include an inlet 72 having an extension 74 which mates with the mounting fixture 28 described in FIG. 2. The coupling between the extension 74 and fixture 28 may seal the inlet 72 such that water may be supplied to the above-ground feature 70 directly into the conduit 76 associated therewith. Alternatively, a separate supply tube 78 may be used to supply water alone or in conjunction with conduit 76 to one or more misting/fogging nozzles 80 or other dispensing nozzles or dispensing features associated with the above-ground feature 70. The feature 70 may have mounting bases 82 associated therewith to secure the feature 70 to the surface on which it is mounted, such as a concrete pad associated with a water park area or the like.

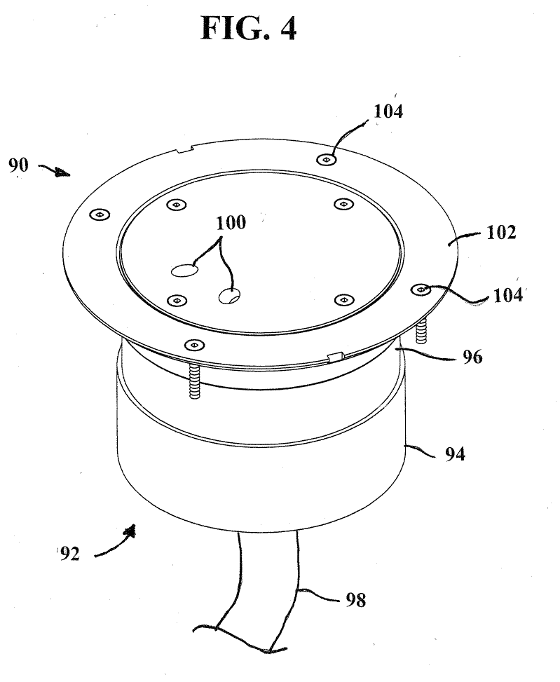

In FIG. 4, there is shown an example of a below-ground water feature 90 which may incorporate the misting/fogging nozzles according to the invention. The below-ground water feature 90 may include an inlet 92 having an extension 94 which mates with the mounting fixture 28 described in FIG. 2. The coupling between the extension 94 and fixture 28 may seal the inlet 92 such that water may be supplied to the below-ground feature 90 directly into the housing 96 associated therewith. Alternatively, a separate supply tube 98 may be used to supply water alone or in conjunction with housing 96 to one or more misting/fogging nozzles 100 or other dispensing nozzles or dispensing features associated with the below-ground feature 90. The feature 90 may have a mounting flange 102 associated therewith to secure the feature 90 to the surface on which it is mounted in a flush type configuration, such as to a concrete pad associated with a water park area or the like.

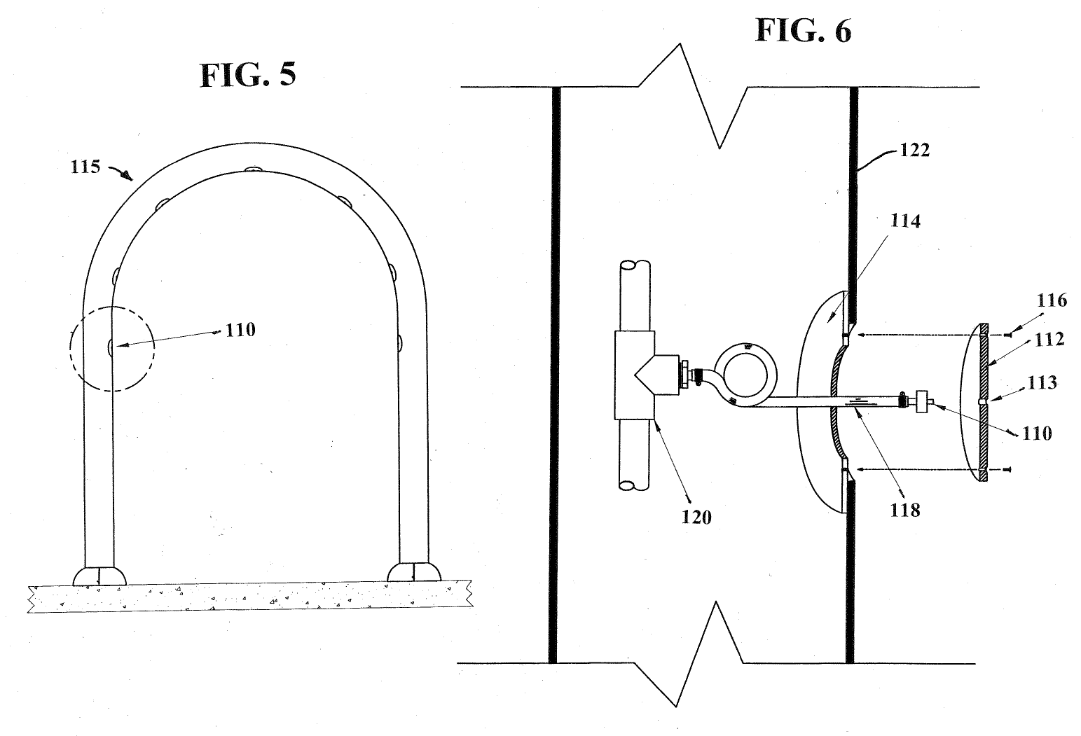

Turning to FIGS. 5 and 6, there is shown the arrangement of a misting/fogging nozzle 110 according to an example of the invention. In FIG. 5, a water feature 115 is shown with a plurality of misting nozzles 110 associated therewith, similar to other examples. In some examples, the nozzle(s) 110 may be supplied with water for producing a misting/fogging output via a supply tube directed to nozzle 110. As shown in FIG. 6, in the arrangement of the water feature 115 in which the nozzles 110 are positioned, each of the nozzles 110 may include an access panel 112 positioned adjacent to or including the nozzle 110 as shown in this example. The access panel 112 has a nozzle orifice 113 through which nozzle 110 extends, and may be secured in position via fasteners 116 for example, in association with a backer plate 114, or in any other suitable manner. The access plate 112 can be selectively removed for access to the nozzle 110, and associated systems such as a supply tubing 118, and the connection thereof to the nozzle 110 for example. The tubing 118 may be connected to a supply piping 120 (such as supply piping 78 or 98 as shown in FIG. 3 and FIG. 4 respectively) for example. The use of a supply pipe 120 for example, as well as a supply tubing 118, allows less volume of fluid or water to be used in supplying the nozzle 110, but the fluid or water may simply be supplied through the feature housing 122 or portion thereof if desired. The provision of an access panel 112 may allow the nozzle 110, tube 118 and/or supply piping 120 to be serviced in a more convenient fashion. The arrangement also allows different types of nozzles 110 to be selectively replaced in the feature to provide for alternative dispensing characteristics to be employed if desired. Other suitable arrangements for access to the nozzles 110 or other systems are contemplated.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. As merely examples, FIGS. 7a-7d show possible features according to the invention, and it should be recognized that the possibilities for such features are essentially endless. In FIG. 7a, a palm tree feature is shown in a stand-alone type of example, with a plurality of misting nozzles producing mist from a number of locations around the feature. FIG. 7b shows a stand-alone feature formed as a dragon that could have misting nozzles to produce mist from the “dragon's” nostrils as well as other locations about the feature. A flow of water may also be made to come out of the dragon's mouth if desired. FIG. 7c shows a bench, that people could sit upon, that has misting nozzles provided thereabout to provide cooling to people sitting thereon. FIG. 7d shows a lighthouse type of feature that has misting nozzles at a variety of locations. Any theme or person, place, thing could be emulated in a feature as should be recognized, while providing unique misting and/or fogging features either alone or in combination with other water, lighting or other aesthetic features.

The examples shown in the figures are provided for the purpose of describing the invention only, and are not intended to exhaustively describe all possible examples and embodiments of the invention. The nozzles may have a desired spray pattern, and a feature may use multiple nozzles around a supply line which together produce a 360 degree spray pattern if desired. A misting system may be configured to provide misting and/or fogging over a predetermined area to be misted or fogged, with nozzles of suitable number and capacity, and spray patterns.

Although the invention has been shown and described in conjunction with examples thereof, the same are considered as illustrative and not restrictive, and that all changes and modifications that come within the spirit of the invention described by the following claims are within the scope thereof.

What is claimed is:

1. A water feature including a misting system for selectively dispensing a fluid in the form of a mist or fog, the feature comprising:
a feature housing having at least one misting nozzle associated therewith,
a supply line to provide a pressurized fluid to the at least one misting nozzle,
a pressurized fluid supply selectively coupled to the supply line to provide a fluid under pressure to the at least one misting nozzle to produce a mist and/or fog therefrom.

2. The feature according to claim 1, wherein said feature housing is selected from the group consisting of an above ground feature and a below ground feature.

3. The feature according to claim 2, wherein said feature housing is an above ground feature having a predetermined aesthetic appearance of an article or thing.

4. The feature according to claim 1, further comprising a pump coupled to the supply line and to a source of fluid to supply fluid under pressure to the at least one misting nozzle.

5. The feature according to claim 1, further comprising a filtering system associated with the supply of fluid to filter the fluid being supplied to the at least one misting nozzle.

6. The feature according to claim 1, further comprising at least one actuator operating a fluid control valve for selectively releasing fluid from said at least one misting nozzle.

7. The feature according to claim 6, wherein the at least one actuator is provided on the feature housing and is operated by a user.

8. The feature according to claim 6, wherein the at least one actuator is operated by detecting the presence of a person in the vicinity of the feature housing.

9. The feature according to claim 1, wherein the at least one misting nozzle is adjustable by a user for interactive operation thereof.

10. The feature according to claim 9, wherein the adjustability is selected from the group consisting of the direction of the at least one misting nozzle, the spray pattern of the at least one misting nozzle, the position of the at least one nozzle or combinations thereof.

11. The feature according to claim 1, wherein the feature housing is built into a structure and has the supply line is selectively coupled to a pressurized fluid supply by a further supply line positioned underground, and the feature housing is selectively coupled to the further supply line by a universal fixture.

12. The feature according to claim 1, wherein the feature housing is coupled to a stand-alone base member, wherein the base member allows the feature to be selectively moved.

13. The feature according to claim 12, wherein the base member includes a pump for supplying high pressure fluid to the at least one misting nozzle.

14. The feature according to claim 12, wherein the base member includes a reservoir for fluid to be selectively supplied to the at least one misting nozzle.

15. The feature according to claim 1, further comprising at least one other fluid dispensing feature associated feature housing.

16. The feature according to claim 1, wherein the pressurized fluid supply is selected from the group consisting of municipal grade pressure of between 10 to 400 psi and higher pressure of between 120 to 3000 psi, or combinations thereof.

17. The feature according to claim 1, wherein the pressurized fluid supply is selected from the group consisting of a hose connected to a municipal grade water supply, a high pressure pump connected to a source of fluid, a high pressure pump connected to a reservoir of fluid and combination thereof.

18. The feature according to claim 1, wherein the at least one misting nozzle is mounted in association with an access member that is selectively removable for access to at least the misting nozzle.

19. A water feature including a misting system for selectively dispensing a fluid in the form of a mist and/or fog, the feature comprising:
a feature housing having at least one misting nozzle associated therewith,
a supply line to provide a pressurized fluid to the at least one misting nozzle,
a fluid supply selectively coupled to the supply line and a pump to provide a fluid under pressure to the at least one misting nozzle to produce a mist and/or fog therefrom, and
at least one actuator operating a fluid control valve for selectively releasing fluid from said at least one misting nozzle.

20. A user actuated water amusement device comprising,
a feature housing having at least one misting nozzle associated therewith,
a supply line to provide a pressurized fluid to the at least one misting nozzle,
a fluid supply selectively coupled to the supply line, a filtration system to filter the fluid supplied to the at least one misting nozzle and a pump to provide a fluid under pressure to the at least one misting nozzle to produce a mist and/or fog therefrom, and
at least one actuator operating a fluid control valve for selectively releasing fluid from said at least one misting nozzle.

21. The device according to claim 19, wherein the at least one actuator is provided on the feature housing and is operated by a user.

22. The feature according to claim 19, wherein the at least one misting nozzle is adjustable by a user for interactive operation thereof, and wherein the adjustability is selected from the group consisting of the direction of the at least one misting nozzle, the spray pattern of the at least one misting nozzle, the position of the at least one nozzle or combinations thereof.

23. A method for providing interactive operation of a water feature comprising,
providing a water feature including a misting system that selectively dispenses a fluid in the form of a mist and/or fog for providing evaporative cooling of a localized area,
selectively coupling a source of pressurized fluid to at least one misting nozzle provided as part of the water feature,
controlling the supply of pressurized fluid to the at least one misting nozzle by a control system operating the water feature, where the control system is user actuated.
